(19) United States
(12) Patent Application Publication
(10) Pub. No.: US 2004/0019633 A1
(43) Pub. Date: Jan. 29, 2004

(54) MIME encoding of values for web procedure calls

(75) Inventors: Glenn C. Scott, Mountain View, CA (US); Robert P. St. Pierre, Sunnyvale, CA (US)

Correspondence Address: LAHIVE & COCKFIELD, 28 STATE STREET, BOSTON, MA, 02109, US

(73) Assignee: Sun Microsystems, Inc., Santa Clara, CA

(21) Appl. No.: 10/205,293

(22) Filed: Jul. 24, 2002

(51) Int. Cl. G06F 15/16

(52) U.S. Cl. 709/203; 709/236

(57) ABSTRACT

A present invention discloses a method of providing a web procedure call by using a MIME encapsulation for data to be passed between parties in a network transaction. A “web procedure call” refers to any interaction between two devices or services in network environment where the calling party requests some activity by the called party (e.g., to accept data or perform a specified task).

### RELATED APPLICATIONS

The illustrative embodiment of the present invention is related to four co-pending applications, A System and Method For Processing Callback Requests Included in Web-Based Procedure Calls, A System and Method For Processing Callback Requests Included in Web-Based Procedure Calls Through a Firewall, System and Method For Dynamically Routing Web Procedure Calls and A System and Method for Forward Chaining Web-Based Procedure Calls, filed concurrently with the present application

### FIELD OF THE INVENTION

The illustrative embodiment of the present invention relates generally to software and more particularly to the encoding of data for Web Procedure Calls using MIME.

### BACKGROUND OF THE INVENTION

One of commonly used method to pass information between entities on the Internet is the Simple Object Access Protocol (SOAP). SOAP provides a way for applications to communicate with each other over the Internet, independent of platforms. SOAP provides a lightweight messaging format that works with any operating system, any programming language, and any platform using the Extensible Markup Language (XML). SOAP includes three parts: the SOAP envelope for defining a framework for describing what is in a message and how to process the message, the SOAP encoding rules for expressing instances of application-defined data types, and a convention for representing remote procedure calls (RPC) and responses. SOAP relies on XML to define the format of the information being passed.

The Extensible Markup Language (XML) is a markup language that is often used to encode web pages. XML defines a class of data objects called XML documents and partially describes the behavior of computer programs which process such documents. XML documents are formed from storage units known as “entities”, which contain either parsed or unparsed data. Parsed data is made up of characters, some of which form character data and some of which form markup. Markup encodes a description of the document's storage layout and logical structure. In other words, XML provides a facility to define tags and the structural relationships between tags. An XML processor is used to read XML documents and provide access to the content and structure of the XML documents.

Use of SOAP with XML encoded data can be restrictive for certain Internet connected devices. Since XML allows the construction of complex document structures, the parse engines for parsing XML documents are complex because the parse engines must be able to handle all possible cases of structures. The XML Document Type Declaration (DTD) contains references to markup declarations that provide a grammar for a class of documents. This grammar is known as a Document Type Definition. The Document Type Declaration can point to an external subset containing markup declarations, or can contain the markup declarations directly in an internal subset, or can do both. The complicated DTD requires a more powerful CPU and also requires sufficient memory for parsing the DTD's.

The present invention address the above problems with passing information by using MIME encapsulation for data to be passed between parties in a network transaction.

### SUMMARY OF THE INVENTON

The illustrative embodiment of the present invention provides a method of providing a web procedure call by using a MIME encapsulation for data to be passed between parties in a network transaction. A “web procedure call” refers to any interaction between two devices or services in network environment where the calling party requests some activity by the called party (e.g., to accept data or perform a specified task). For example, service A can request a service to service B in a web procedure call and service B can return the result to service A via a web procedure call.

One novel aspect of the present invention is that MIME is used to encode web procedure call transactions. This is contrast to how MIME is typically used, which is to encode e-mail.

In accordance with one aspect of the present invention, a method is practiced in an electronic device. Initially, the data is encoded using MIME for a web procedure call. The electronic device can send the data to a web server for a client/server environment or to another electronic device for a peer to peer environment. Once the data is received by the receiving entity, the data will be decoded using MIME.

In one embodiment of the present invention, many predefined data types in MIME can be utilized when encoding a data. For example, MIME predefines data types such as character sets other than ASCII, enriched text, images, sounds, tar files, PostScript and FTPable file pointers. Also, the present invention uses MIME to allow the new definition of data type by user.

In another embodiment of the present invention, multiple data types in a document are supported using Multipart MIME. A document may contain a text, an image, a bit-array and an XML document.

### BRIEF DESCRIPTION OF THE DRAWINGS

FIG. 1 depicts a block diagram of a client/server environment suitable for practicing the illustrative embodiment of the present invention;

FIG. 2 depicts a block diagram of a peer to peer environment suitable for practicing the illustrative embodiment of the present invention;

FIG. 3 depicts a block diagram of web procedure calls; and

FIG. 4 depicts a flow chart illustrating the steps that are performed in the illustrative embodiment.

### DETAILED DESCRIPTION OF THE INVENTION

The illustrative embodiment of the present invention provides a method of providing a web procedure call by using a MIME encapsulation for data to be passed between entities in a network. The benefits of using MIME encoding and decoding rather than using XML include avoiding the heavyweight parse engines of XML. For most of client-server or peer-to-peer operation, XML can be overkill and waste of resources such as a CPU and the Memory to parse the XML's complex document structure.

The illustrative embodiment of the present invention has many advantages compared to using XML as an encoding scheme. XML encoded data can be restrictive for small Internet connected devices, due to large size of parser. Since XML allows the construction of complex document structures, the parse engines is complex to handle all cases. Therefore, the CPU and memory requirements for parsing the XML data can be problem for small Internet connected device. Compare to the XML parser, the MIME parser is simpler and smaller and requires less resource such as the CPU and memory. For small Internet connected device, the efficiency is a critical component and XML might be overkill.

Another advantage of the MIME encoding scheme of the illustrative embodiment is that it is easily transferred over both Hyper Text Transfer Protocol (HTTP) and Simple Mail Transfer Protocol (SMTP) for both interactive service, and store and forward based service. HTTP defines how messages are formatted, and what action Web servers and browsers should take in response to various commands. SMTP is a protocol for sending e-mail messages between servers. Most e-mail systems that send mail over the Internet using SMTP to send messages from one server to another.

Another advantage of the MIME encoding scheme of the illustrative embodiment compared to an XML encoding scheme is that MIME already provides many predefined and well understood data types such as text/plain and image/jpg.

A further advantage is that the illustrative embodiment of present invention is well suited for transfer of binary data. Binary data refers to any sequence of octet data.

In order to better understand the illustrative embodiment, it is helpful to first review MIME principles. The Multipurpose Internet Mail Extensions (MIME) is a specification for the format of non-text email attachments that allows the attachment to be sent over the Internet. MIME allows a mail client or web browser to send and receive things like spreadsheet files, audio files, video files and graphics files via Internet mail.

MIME was defined in 1992 by the Internet Engineering Task Force (IETF). MIME defines the standard format of textual mail messages on the Internet. The distinguishing characteristic of a MIME message is the presence of the MIME headers in email messages. When a MIME ready e-mail system receives a MIME encoded file, the binary file appears as an attachment and software in the computer reads the file.

The MIME-version header field uses a version number to declare that a message conforms to the MIME standard. The content-type header field can be used to specify the type and subtype of data in the body of a message and to fully specify the encoding of such data. In other words, the content-type field describes the data contained in a body fully enough that the mail reader can pick an appropriate mechanism to present the data to the user.

The content-type header field is used to specify the nature of data in the body or body part, by giving type and subtype identifiers, and by providing parameters that may be needed for certain types. The top-level content-type is used to declare the general type of data, while the subtype specifies a specific format for that type of data. The content-type text can be used to represent textual information in a standardized manner. The content-type multipart can be used to combine several body parts, possibly of different types of data, into a single message. The content-type application can be used to transmit application data or binary data. The content-type message can be used to encapsulate a mail message. The content-type image can be used to transmit an image data. The content-type audio can be used to transmit an audio or voice data. The content-type video can be used to transmit a video data.

The content-transfer-encoding header field specifies how the data is encoded to allow the data to pass through mail transports. The possible values for the content-transfer-encoding field are base64, quoted-printable, 8 bit, 7 bit, binary, and x-encodingName. Both base64 and quoted-printable imply an encoding that consists of lines no longer than 76 ASCII characters. The encoding scheme implied by quoted-printable is used for data that consists primarily of printable ACSII characters. The base64 encoding mechanism is well suited for representing binary files. The values 8 bit, 7 bit and binary all imply that no encoding has been performed. They are useful to indicate of the kind of data contained in the object, and therefore of the kind of encoding that might need to be performed for transmission in a given transport system. 7 bit means that the data is all represented as short lines of ASCII data. 8 bit means that that line are short, but there may be non-ASCII characters. Binary means that not only may non-ASCII characters be present, but also that the lines are not necessarily short enough for SMTP transport. X-encodingName refers to any additional values for encoding to indicate its non-standard status. Also, the content-ID and content-description header fields can be used to further identify and describe the data in a message body. The content-description header field allows the association of descriptive information with a body such as an image title.

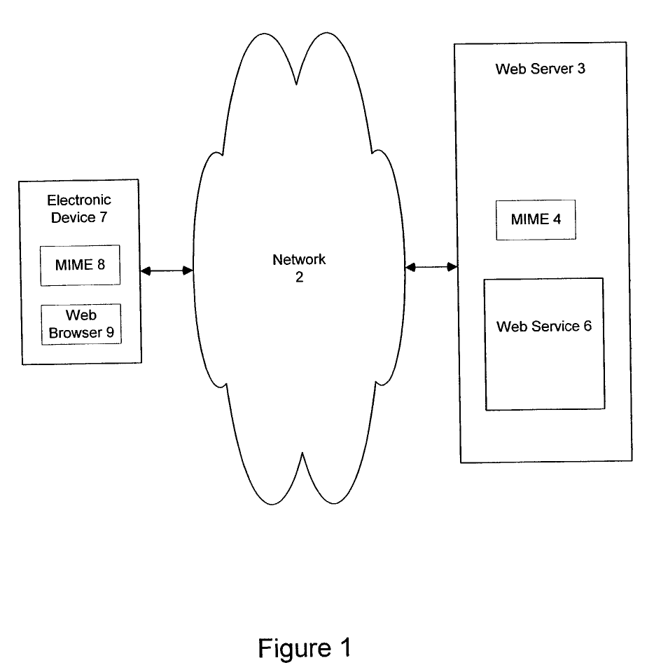

FIG. 1 depicts a client/server environment suitable for practicing the illustrative embodiment of the present invention. A network 2, such as the Internet, is interfaced with a web server 3. The network 2 may also be a wireless network, a local area network (LAN) interfaced with another network, or some other type of network that directs internal traffic through a proxy server enroute to an external location. The web server is an electronic device that delivers web pages and provides web services. Most of the web server has an IP address and a domain name. Any computer can be turned into a web server by installing server software and connecting the machine to the Internet. The web server 3 provides a web service 6 and MIME 4 support for web procedure calls. An electronic device 7 is also interfaced with the network 2. The electronic device 7 may be a desktop computer system, workstation system, PDA, handheld wireless device, laptop computer, cellular phone or other device interfaced with the network 2. The devices may be physically connected or connected using wireless technology. The electronic device 7 also may include a web browser 9 and MIME 8 support for web procedure calls.

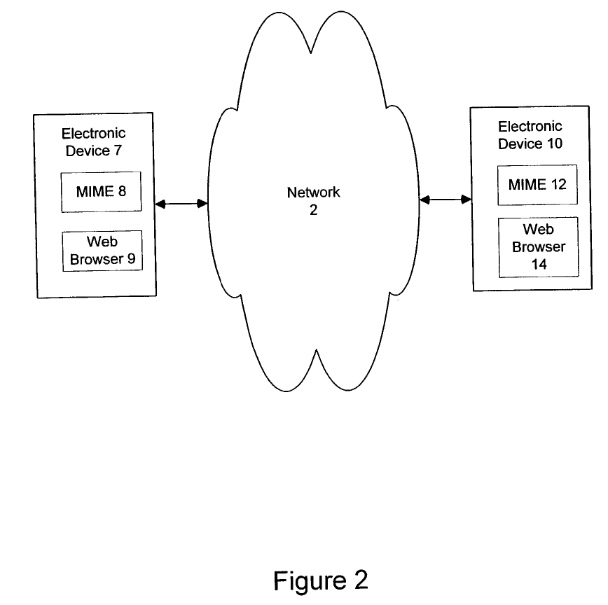

FIG. 2 depicts a peer to peer environment suitable for practicing the illustrative embodiment of the present invention. A network 2, such as the Internet, is interfaced with a first electronic device 7. A second electronic device 10 is also interfaced with the network 2. The electronic devices 7 and 10 also may include a web browser and MIME support for web procedure calls. The electronic devices 7 and 10 may take many forms, such as the devices discussed above relative to FIG. 1.

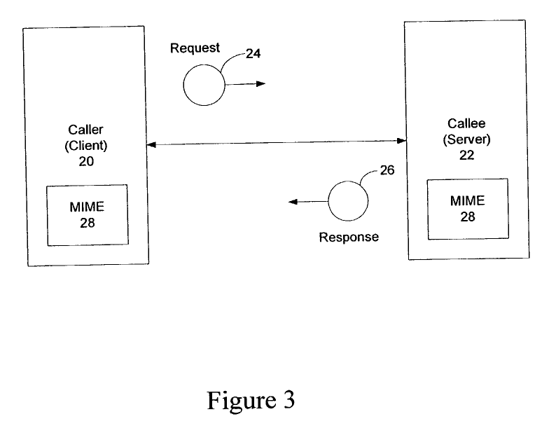

FIG. 3 depicts an example of web procedure calls accord per the illustrative embodiment. The two entities shown in FIG. 3 can be categorized as client and server or as peers depending on the environment. For a client/server environment, the client 20 is the participant that invokes an operation and the server 22 is the participant implementing or responding to the operation. The message is the basic unit of communication. In the illustrative embodiment, the MIME protocol is used for data encoding. The request message 24 is sent from the client 20 using MIME encoding. Server 22 decodes the MIME data based on MIME protocol then process the request 24 from the client 20. Server 22 then sends the response 26 using MIME data encapsulation.

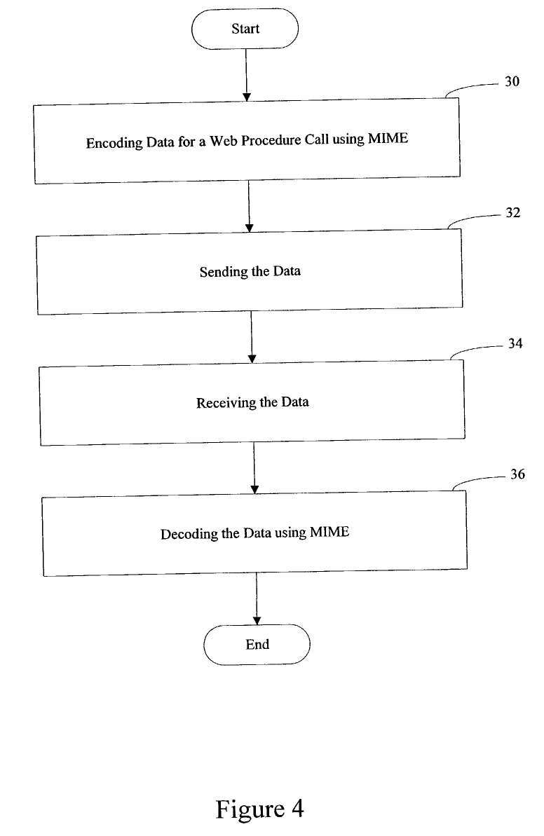

FIG. 4 depicts a flow chart illustrating the steps that are performed in the illustrative embodiment. Initially, the data is encoded using MIME for a web procedure call (step 30 of FIG. 4). Next, the electric device sends the data, such as in an HTTP request or HTTP response (step 32). The data is received by the receiving entity (step 34). Lastly, the data is decoded using MIME by receiving entity (step 36).

While MIME is commonly used to encode the files and e-mail messages, the illustrative embodiment of present invention uses MIME extensions to allow the definition and encapsulation of data values. For example, definitions for data types are shown below for illustrative purpose.

x-value/integer

x-value/float

x-value/octet-string

x-value/bit-array

The x-value is used as an example of a class of MIME type for illustrative purpose. Those skill in the art would appreciate that actual implementation can be change by designer's preference.

The present invention supports for multiple MIME types in a document using Multipart MIME. Multipart message contains multiple body parts, each having its own data type. An example of Multipart MIME encapsulated message is shown in below as an example which contains two text/plain, an image, a bit-array and an XML document.

MIME-Version: 1.0

Content-Type: multipart/mixed;

This is a multi-part message in MIME format.

boundary=“ - - - 9D5D373F369F78757FA67C00”

- - - 9D5D373F369F78757FA67C00

Content-Type: text/plain; name=location

Content-Transfer-Encoding: 7 bit

Mountain View, Building 29

- - - 9D5D373F369F78757FA67C00

Content-Type: text/plain; name=mailstop

Content-Transfer-Encoding: 7 bit

UMTV29-235

- - - 9D5D373F369F78757FA67C00

Content-Type: x-value/bit-array; name=bitmask

Content-Transfer-Encoding: 8 bit

11010001

- - - 9D5D373F369F78757FA67C00

Content-Type: image/jpg; name=pic

Content-Transfer-Encoding: base64

/9j/4AAQSkZJRgABAQAAAQABAAD/2wBDAAgGBgcGBQgHBwcJCQgKDBQND

AsLDBkSEw8UHRofHh

- - - 9D5D373F369F78757FA67C00

Content-Type: plain/xml; name=config

Content-Transfer-Encoding: 7 bit

<! - - - Here begins and excerpt of a configuration file in XML. - - - >

<supernet configuration>

<supernet name=“swan.Sun.COM” id=“Oxcafeface”>

<dns nameserver=“10.0.0.1” domain=“localdomain”/>

<supernet configuration>

- - - 9D5D373F369F78757FA67C00

For above illustrative example, the heading of the message shows that the MIME-Version is 1.0 and content-type is multipart with each data is separated by boundary, - - - 9D5D373F369F78757FA67C00; For first data, it describes the location. MIME encoding utilizes a content-type header field to define a name for the data such as the location in this illustrative example. Content-type is text/plain. Content-transfer-encoding using 7 bit, and value for the location is Mountain View, Building 29. For second data, it describes the mailstop. Content-type is text/plain. Content-transfer-encoding using 7 bit, and value for the mailstop is UMTV29-235. For third data, it describes the bit mask. Content-type is the x-value/bit-array. Content-transfer-encoding using 8 bit and value for the bit mask is 110100001. For fourth data, it is a picture. Content-type is image/jpg. Content-transfer-encoding using base64, and the image bits are shown. For fifth data, it describes the XML document called the config. Content-type is plain/xml. Content-transfer-encoding is using 7 bit, and the XML document is shown.

It will thus be seen that the invention attains the objectives made apparent from the preceding description. Since certain changes may be made without departing from the scope of the present invention, it is intended that all matter contained in the above description or shown in the accompanying drawings be interpreted as illustrative and not in a literal sense. The description and illustrations shall not be construed as limiting the invention. Rather, it is intended that the invention be limited only to the extent required by the appended claims and the applicable rules of law. Practitioners of the art will realize that the network configurations depicted and described herein are examples of the multiple possible network configurations that fall within the scope of the current invention.

We claim:

1. In a first electronic device coupled to a network, a method, comprising the steps of:
encoding data for a web procedure call using MIME; and
sending the data from the first electronic device on to the network toward a second electronic device.

2. The method of claim 1, wherein the network is the Internet.

3. The method of claim 1, wherein the network is a wireless network.

4. The method of claim 1, wherein the MIME encoding utilizes a content-type header field to define a name for the data.

5. The method of claim 1, wherein the MIME encoding allows a definition of the data type and assigns a data value to the data.

6. The method of claim 1, wherein the web procedure call is made in a client/server environment.

7. The method of claim 1, wherein the web procedure call is made in a peer to peer environment.

8. The method of claim 1, wherein the data is a multipart message, said multipart message includes multiple types of data.

9. A medium for use in a first electronic device coupled to a network, said medium holding instructions for performing a method, comprising the steps of:
encoding data for a web procedure call using MIME; and
sending the data from the first electronic device on to the network toward a second electronic device.

10. The medium of claim 9, wherein the network is a wireless network.

11. The medium of claim 9, wherein the MIME encoding utilizes a content-type header field to define a name for the data.

12. The medium of claim 9, wherein the MIME encoding allows a definition of the data type and assigns a data value to the data.

13. The medium of claim 9, wherein the web procedure call is made in a client/server environment.

14. The medium of claim 9, wherein the web procedure call is made in a peer to peer environment.

15. The medium of claim 9, wherein the data is a multipart message, said multipart message includes multiple types of data.

16. In an electronic device coupled to a network, a method, comprising the steps of:
decoding a message using MIME, said message is encoded in MIME; and
performing the encoded web procedure call.

17. The method of claim 16, wherein the network is a wireless network.

18. A medium for use in an electronic device coupled to a network, said medium holding instructions for performing a method, comprising the steps of:
decoding a message using MIME, said message is encoded in MIME; and
performing the encoded web procedure call.

19. The medium of claim 18, wherein the network is the Internet.

20. The medium of claim 18, wherein the network is a wireless network.
